(19) United States
(12) Patent Application Publication
(10) Pub. No.: US 2009/0123741 A1
(43) Pub. Date: May 14, 2009

(54) Lithographic Printing Plates and Processes for Making them

(76) Inventors: Jivan Gulabrai Bhatt, Karnataka (IN); Anantaraman Iyer Thyagarajan, Maharashtra (IN); Manelal Chirayil Jacob Kurian, Maharashtra (IN); Shreekant Damle Aniruddha, Maharashtra (IN)

Correspondence Address: LAWSON & WEITZEN, LLP, 88 BLACK FALCON AVE, SUITE 345, BOSTON, MA, 02210, US

(21) Appl. No.: 12/227,122

(22) PCT Filed: May 8, 2007
(86) PCT No.: PCT/IN2007/000180

§ 371 Date: Jan. 22, 2009

(30) Foreign Application Priority Data
May 10, 2006 (IN) 729/MUM/2006

(51) Int. Cl. B32B 27/32; B32B 27/34; B32B 27/36; B05D 3/10

(52) U.S. Cl. 428/337; 428/412; 428/473.5; 428/480; 427/322

(57) ABSTRACT

A novel lithographic printing plate suitable for use with inkjet printers as image forming devices and a method for making such a plate is disclosed. The novel lithographic printing plate according to this invention comprises: (a) a substrate; (b) at least one base coat provided on the substrate, said base coat obtained from a composition comprising, in a first solvent (i) at least one first hydrophilic binder, (ii) a mixture of pigments comprising at least one porous hydrophilic pigment and at least one non-porous hydrophilic pigment, (iii) at least one first cross-linking agent, and (iv) at least one first catalyst; and (c) at least one top coat provided on the base coat, said top coat obtained from a composition comprising, in a second solvent (i) at least one second hydrophilic binder, (ii) at least one hydrophilic pigment in particulate form, wherein at least 10% of the pigment particles have particle size of about 3-15 micron (iii) at least one second cross-linking agent, and (iv) at least one second catalyst.

### FIELD OF THE INVENTION

The present invention relates to a novel lithographic printing plate. Particularly, the present invention relates to a novel lithographic printing plate suitable for use with inkjet printers as image forming devices and a method for making such a plate

### BACKGROUND OF THE INVENTION

Industrial printing involves large scale production of printed materials such as text and/or images and is a major industry. A variety of methods are known in the prior art for industrial printing. Conventionally, the printing is accomplished by using metal blocks having uneven surfaces. Typically, the block has raised and etched surfaces. The surface above the plane (raised surface) comes in contact with the ink and transfers the ink whereas the surface below the plane (etched surface) does not receive or transfer any ink. With a growing need for quick and bulk printing, the conventional printing methods have also undergone several improvements.

Lithographic printing is one such improved method of industrial printing wherein the printing surface is neither raised nor etched into the plate but has printing and nonprinting areas on the same plate. In lithographic printing, the printing is affected by means of a chemical process that allows ink to adhere to only parts of the surface to be reproduced. The process developed in the late eighteenth century depends on the fact that water and grease repel each other. In old times, the image to be reproduced was drawn on a slab of stone with a grease crayon. The stone was then dampened with water. The grease from the crayon would repel the water so that, when a grease-based ink was rolled across the stone, the ink would adhere only to the drawing, later to be transferred to the paper. Lithography (“writing on stone”) is based on a similar principle with stone replaced by a metal plate and many other significant improvements. Lithography is less expensive than either letterpress or gravure printing and is a reasonable alternative, particularly for short run applications.

Modern lithographic printing uses oil based ink. In offset lithographic printing, the lithographic printing plate (master) has on its printing surface an oleophilic-ink receiving area distinctly separated by a hydrophilic—water receiving area. By applying ink and water together or water and ink in this order to the lithographic plate, the oleophilic area attracts and gets coated with oil based ink. The remaining area is protected from ink absorption by a thin layer of water held by virtue of the hydrophilic nature of this area. The image is then transferred on to a blanket as a reverse image. The final image is transferred on to the paper as a readable image.

The offset lithography printing is different from other printing processes such as Flexo or Gravure printing which are also commonly used in commercial printing applications. Gravure or Intaglio printing has images which are engraved on a metal or any suitable hard material. The ink which is deposited in the engraved area gets transferred on to the paper during the printing process. The Flexo printing is a relief printing process in which the image is projected from a stereo base. In case of a waterless offset printing process, the image is created by inked and non-inked areas of the plate surface characterized by the differential surface energy of these areas created using a silicone-formulation.

Images on lithographic plates are traditionally created by a photographic process. The plate is often an aluminum plate grained by a chemical or electrolytic treatment to render the printing/surface hydrophilic. The hydrophilic substrate is then coated with the photosensitive layer which works as an oleophilic layer. The coating thickness of the layer depends on various factors such as speed of processing, plate run length, image quality and the like. At least one layer on the plate coating is sensitive to light of certain wavelength. Ultra-violet, visible or infrared light-sensitive coating compositions for lithographic printing plates are well known in the art. Many conventional plates, sensitive in the 325 nm to 400 nm range, are based on diazo materials. Lithographic printing plates suitable for offset printing are typically produced from these plates via processes similar to a photographic process.

To prepare a lithographic precursor for use as an offset printing plate, commonly referred to as a lithographic master, in order to differentiate between the blank plate (the precursor) and the processed plate (the master), the plate is first exposed to light in the pattern to be printed using a photographic film negative. The exposed plate is then washed in a developing solution. In one group of plate products, known as negative-working plates, the exposed areas of the plate coating are insoluble and the development process quantitatively removes the unexposed areas of the coating from the hydrophilic aluminum surface of the plate substrate. By convention, such a preparation process is referred to as a negative-working process because the unexposed coating is removed. Diazonium salt-based plates, as a specific group, represent a typical example of conventional ultra-violet-sensitive negative-working plates. Conversely, in a positive-working process, the pattern to be printed is masked and the photosensitive exposed coating is rendered soluble in a developer. Until after the development step, the printing artisan or press operator generally endeavors not to allow incidental exposure of the plate to typical white light or sunlight. Undeveloped plates are typically handled only in low light or “yellow light” rooms or such protected conditions recommended by the supplier.

Traditionally, lithographic precursors have been imaged by photographic transfer from original artwork. Unfortunately, this process is labor-intensive and costly. Hence, a relatively new alternative was developed in which digital data could be directly written on the plate with the aid of computer and a controlled laser writing equipment. These systems are called digital plate setters and the process is termed as Computer to Plate System (CTP).

The CTP system has also undergone several improvements over the time. In one type of CTP systems, commonly known as ablative thermal process, the image is imparted to the plate by ablating away non-printing areas (inherently positive-working). More recently, thermal plates imaged with lower power laser beams that induce, by various mechanisms, a change in the hydrophilicity or oleophilicity of the imaged area have also been known. Typically but not exclusively, low cost ‘near IR diode’ lasers are employed and light-to-heat converter materials are added to the coating on the precursor to adapt the precursor to the wavelength of the laser. Both positive and negative working variants of such media have been developed. Infra red (IR) light sensitive coatings are used in other systems to impart required change after processing.

In most of the above processes, creation of hydrophilic layer is a key step. Aluminum is preferred over other metals as substrate. The earlier employed manually ground surface of aluminum as the hydrophilic surface. Such process had major drawback in manufacturing plates in bulk and was later replaced method wherein the hydrophilic aluminum oxide was created using electrochemical process. Electrochemical process is a critical process in the production of lithographic plate. Many companies have developed customized electrochemical systems to suit process requirements in tune with the quality and productivity requirement and considering environmental restrictions. The coating, whether it is for a conventional plate or CTP, positive or negative, created a hydrophobic layer on top, using the processes mentioned above. The recent CTP processing systems have been relatively large, complex, and expensive and have sophisticated servo-mechanics and optics for managing light from laser arrays and provide required resolution on the plate over large areas. Such systems are suitable for large printing houses such as News Paper printers because of their higher initial investment.

There remains a strong need for a low cost, economical and efficient CTP system for small volume print requirements where relatively lower print resolutions are acceptable. This need has further fueled research in developing newer versions of low cost CTP systems, especially for print job which have low print volumes and textual content such as hand outs, labels, product literature, bill books etc. in such applications, polyester films coated with a hydrophilic coating are used. Typically, direct printing from a laser printer or an image transfer using a copier employed. Typically, these plates are suitable for about 20,000 print impressions. Several such systems are commercially available including those from Kimoto, Technova Imaging Systems, AGFA, Autotype International etc.

One of the major drawbacks associated with the use of laser imaging process is the print size. Typically, laser printers are limited to a size of less than about 350 mm in width and about 550 mm in length. These size limitation, make laser printing process unsuitable for many applications involving larger dimensions. These are not suitable for a vast majority of printing presses available. In recent years, inkjet printers have replaced laser printers as the most popular hard copy output printers for computers. Inkjet printers have several competitive advantages over laser printers. One advantage is that, as a result of semiconductor processing technological advances, it is possible to manufacture arrays of hundreds of inkjet nozzles spaced very accurately and closely together in a single inexpensive print head. This nozzle array manufacturing capability enables fast printing inkjet devices to be manufactured at a much lower cost than laser printers requiring arrays of lasers. The precision with which such a nozzle array can be manufactured, combined with the jetting reliability of the incorporated nozzles, allow these arrays to be used to print high quality images comparable to photographic or laser imaging techniques.

Ink jet printing involves a continuous stream of ink droplets guided with a deflector. This technology commonly known as continuous inkjet printing is now used for industrial and technical application and is not very common in the commercial inkjet printing. Commercial printers currently available in the market use the “drop on demand” or DOD inkjet technology. The two common DOD technologies are thermal and piezo.

Ink receptive coatings for colour and black and white print are a well known subject now for the people in the art. The coating of such a media requires special formulation to hold the ink in its position without smudging. Two main types of coatings are available irrespective of the base media, viz. matte coating and gloss coating. The name is obvious from the appearance of the coated surface. The gloss coatings were predominantly of the swellable type and were created by coating a swellable polymer or a mixture of such polymers. These polymers include water soluble polymers such as Poly vinyl alcohol, polyvinyl pyrrolidone, polyvinyl caprolactum, starch and its many derivatives, cationic polymers such as Poly DADMAC and its derivatives.

The cationic polymers such as modified PolyDADMAC have another special function of fixing the dyes in the inks thereby imparting stability to the printed images. These polymer coatings were doing well until the microporous coatings and cast coated papers were available for ink jet printing. These coatings have an instant drying property owing to the availability of the numerous micro pores on the surface, which can penetrate the ink vehicle in to the coating very fast by the capillary effect of the coating. The other advantage of such a precursor is that they can absorb both dye based and pigment based inks. (these material have capability of accurate image reproduction from an inkjet printer but are not capable of making further copies from an offset printing machine as the surfaces are neither strong enough to withstand the abrasion in the printing process nor are they sufficiently hydrophilic to have clean background of the reproduction. The inkjet printing equipment has also undergone several improvements over the time, especially with respect to their electronic and mechanical components used therein. Printers capable of delivering up to 5760 dpi are available in various sizes for a variety of applications. Inkjet printers are increasingly being used for prepress proofing and other graphic art applications requiring very high quality hard copy output. In spite of the large and rapidly growing installed base of inkjet printers for hard copy output, inkjet-printing technology is not commonly used in CTP systems. A few companies in the industry had initiated the process of making use of the ink jet technology for lithographic plate making process. Some patent applications relate to these developments including published US patent application Nos. 20040123761, 20040051768 and 20050266348.

Some inkjet CTP systems are known in the prior art. The first and commercially available ones include a normal positive pre-sensitized plate top coated with an ink receptive coating. This is a conventional lithographic metal plate top coated by the manufacturer or the user itself, formulations of such an inkjet receptive coating are known to those in the inkjet coating industry. The plate is directly printed using an ink jet printer using a high density black ink and then flood exposed and processed as a conventional plate. The main draw back of the process is that this is a combination process and do not have the full advantage of a process less CTP plate. Moreover, speed of the process can not be achieved in this method. Many people have tried special jetting vehicles for several applications.

U.S. Pat. No. 5,970,873 discloses a jetting of a mixture of a sol precursor in a liquid to a suitably-prepared printing substrate. However, any ink constituents of limited solubility will render unlikely the practical formulation of jettable, shelf-stable ink. A similar problem exists in other formulations disclosed in U.S. Pat. No. 5,820,932 (complex organic resins are jetted) and U.S. Pat. No. 5,738,013 (using a marginally-stable transition metal complexes in the jetting vehicle).

Another requirement of an inkjet CTP system to be of wide utility, is that the system must be able to prepare printing plates with small printing dots, approximately 25 microns in diameter or smaller, so that high resolution images can be printed. Inkjet printers can produce such small dots, but of those having substantial commercial acceptance. Only inkjet printers employing aqueous-based inks and other low viscosity carriers or solvents are practically capable of printing such small dots. Thus, the systems described in U.S. Pat. Nos. 4,003,312; 5,495,803; 6,104,931 and 6,019,045, which use high viscosity hot melt inks make it difficult to prepare high resolution printing plates necessary for printed images of high quality.

Yet another requirement is that the ink layer on the prepared printing plates must be rugged, capable of absorbing lithographic inks and sustaining press runs of many thousands of impressions. The dye based inks used in many commercial printers do not absorb the lithographic inks. The waxes used in the hot melt inks described in U.S. Pat. Nos. 6,019,045 and 4,833,486 wear out in long press runs, limiting commercial use of such plates.

Still another requirement of a successful inkjet-based CTP system is that a mature plate technology is to be preferred. There are many tradeoffs in the manufacture of commercially-practical lithographic precursors. They must be highly sensitive to the imaging process and yet thermally stable, stable in high humidity storage environments, day light applications and resistant to fingerprints. The manufacturing technology as well as the product should be of minimal toxicity and environmentally safe. The plates should either be of “no process” or involve very easy and user friendly processing steps, in which small dots are quantitatively resolved without dot blooming. More over such plates should be cost effective in comparison with other imaging processes for practical use by commercial printers.

U.S. Pat. No. 5,695,908 describes a process for preparing a printing plate comprising a plate coating containing a water-soluble polymer that becomes water-insoluble in contact with a metal ion in a solution jetted image wise. Such systems have become unacceptable due to the cumbersome processing steps involved.

One of the several methods which promise a practical solution is the use of a matte coated ink jet precursor as used in the matte coated ink jet paper. Such coatings, which are familiar to people in the art have been so far used for direct printing of image and not used as a printing plate. These coatings with modifications can be effectively put in to use as printing plates. US Patent application No. 20050266348 teaches use such a process. Similar methods are described in other patent applications such as US patent application no. 20040051768 and 20040125188.

One of the other major challenges of the development of such a coating is the coating thickness required for such an application. The best commercial inkjet printer available till today can generate a 3 pico liter drop. The size of the drops will be around 15 micron on the substrate. But practically the diameter is higher due to the tailing of the drops and the spreading while the drops fall on the printing substrate. Control of the spread is a real challenge in the design of such a plate.

Yet another requirement of the development of an ink jet substrate as a printing plate is that a plate which is developed for rapid absorption of the ink can also absorb sweat, grease, oil and dirt from the hand while handling the plate. One of the methods to avoid the handling problem is described in the US patent application No. 20040051768 and 20040125188. In this method a hydrophilic binder such as a gum is coated on the top layer of the pigmented coating. US patent application No. 20050266348, co-authored by the current inventors had solved this problem by incorporating a second pigment which can absorb the oil and dirt superficially, which will thereafter be released by the printing chemicals used in the lithographic printing process.

The other major requirement for a commercially viable product is that the coating should have strength to withstand the required print run length. The coating should be hard enough to withstand the required number of impressions and at the same time it should have the capability to absorb and fix the inkjet ink fast enough to practically use the technology for commercial printing.

There are a number of indirect approaches described in the prior art making use of the inkjet technology as a means of creating an inkjet plate. In many of these disclosures the development was a chemical reaction between the components of the plate and the ink which then required the use of a proprietary ink for the purpose of creating a printable image. The use of such chemically modified ink systems did not succeed in the commercial market due to the fact that the inkjet printing machines were not suitable for handling many of these ink systems, or the machine suppliers were not supporting the use of such “foreign” inks in their machine. The withdrawal of the guarantee was a major block towards commercial success of such imaging systems. A few of such prior art are summarized below.

U.S. Pat. No. 5,260,163 describes diffusion of a reactant from inkjet inks into a plate coating and reaction with the plate coating. The reaction makes development of the plate different in the imaged and the non imaged area, allowing it possible to create a printable plate after a chemical development by a specified chemical formulation. U.S. Pat. No. 5,275,689 describes diffusion of a reactant from inkjet inks into a plate coating and reaction therewith. The acid is delivered by the specified inkjet ink to initiate an acid-catalyzed reaction which produces a plate coating that is developable in a developer liquid.

U.S. Pat. No. 5,695,908 discloses a technology involving diffusion of a reactant from inkjet inks into a plate coating to produce a chelate complex by a reaction between metal ions from the ink and functional groups on the binder of the plate coatings. The imaged area thus becomes insoluble in the developing solution, which allows removal of the plate coating in the unprinted area.

U.S. Pat. No. 5,466,653 describes the use of a chemical reaction between ink and plate coating. The combination makes an esterification reaction between carboxylic groups and an esterifying agent. This causes the plate coating to become less developable in a developer liquid.

U.S. Pat. No. 5,750,314 explains a method of applying a developer-insoluble inkjet ink onto a developer-soluble plate coating. The inkjet ink images form a mask that prevents developer from reaching the developer-soluble coating in the areas covered by the inkjet ink. This method of masking would suffer from poor image quality due to undercutting.

U.S. Pat. No. 6,050,193 further describes a developable plate coating. The differential development rate of this plate coating is reduced in the image area as compared to non image area. The ink composition includes a sol-precursor, such as, a multi-acetoxy silane, which can undergo self-condensation to form a particulate material or condensation with the plate coating.

U.S. Pat. No. 6,187,380 discloses a printing plate produced directly by reactants, which polymerize alone or in combination with other reactants precoated on the plate substrate to form a printable hard resin image.

One of the practical application of the inkjet CTP is the use of an aluminum plate which is made hydrophilic by electrochemical or by other means such as physical etching such as sand blasting etc. as known to the people in the art of manufacturing lithographic plates and the use of UV curing ink. The UV curing inks contain acrylic moieties which absorb lithographic inks and give a reasonable quality inkjet CTP plate. Currently such inks are available for special application and are not cost effective as other inks available for commercial inkjet printing.

Commercial ink jet printers have become more and more advanced with respect to speed and resolution and its capability to produce wide color gamut. These printers allow use of combination of light and dark shades of colors there by making image reproductions better than lithographic printing. They have been therefore used widely as proofing machines in the prepress activity. Aqueous ink jet inks were of two types, pigment based and dye based. Dye based inks having better color saturation and brilliancy show tendency to fade very fast. The pigment based inks were color fast but were of poor brilliancy. Recent inventions of micro fine pigments have made improvements in the pigment based inks and they have become favorites of the printing industry.

The availability of an inkjet plate which can be imaged using a commercially available ink jet printer and the inks supplied or supported by the inkjet printer manufacturer will be the most preferred CTP system. Such a system will not call for additional equipment and process other than that is used by the user for their prepress activity. This reduces the total inventory as well as space requirement.

US Patent application No. 20040123761 and 20040051768 describes method of preparation of a lithographic plate which can be imaged using a commercially available ink jet printer using the inks supplied by the inkjet printer supplier. This proposition is viable as the end customer can use a commercially available printer and inks compatible with the printer and use the same without breaking the usual guarantee clauses for using the printer. Many suppliers of inkjet printers withdraw their warrantee for the printer in case of use of a non standard ink which is not recommended by the supplier). However the invention use a hydrophilic water soluble layer on top of a pigmented coating to protect the ink receptive pigmented layer from oil, grease, sweat etc. A plate made with such teaching has made the plate slow drying. Furthermore, the ink gets dissolved in water or the fountain solution used in the press. The plate then needs to be heated for a period of more than 10 minutes at 100° C. This makes the plate unviable for a commercial CTP environment.

US patent application No. 20050266348 claims a method of preparation of a lithographic plate which can be directly imaged using a commercially available ink jet printer which do not have any top coat. This patent explains the use of a combination of hydrophilic pigments to avoid the hand marks happening during handling of the plate. However the plate prepared by this method also needed prolonged fusing for a reasonable run length.

Polyester films coated only on one side have a tendency to curl as the shrinkage of the uncoated and coated sides vary when heated in the oven. Hence it is a practice in many products requiring dimensional stability to coat on both sides even if only one side is used. However, such coatings are costly, and therefore there is still a need for a product which is cost effective.

Therefore, there is a need to provide a method of preparing a lithographic printing plate which can be imaged on a commercial inkjet printer using pigment ink, which do not require any post imaging treatment and which can be used on both sides so that it qualifies for requirement of a cost effective inkjet CTP system.

### OBJECTS OF THE INVENTION

It is an object of the present invention to provide a lithographic printing plate suitable for use with inkjet printers as image forming devices.

It is another object of the present invention to provide a lithographic printing plate having higher run length.

It is yet another object of the present invention to provide a lithographic printing plate which is highly sensitive to the imaging process.

It is a still another object of the present invention to provide a lithographic printing plate which is thermally stable.

It is a further object of the present invention to provide a lithographic printing plate which is stable at higher humidity environments for longer duration.

It is yet further object of the present invention to provide a lithographic printing plate which is suitable for daylight operation.

It is still further object of the present invention to provide a lithographic printing plate which is resistant to various undesired processing effects such as finger prints.

It is another object of the present invention is to provide easy to use lithographic printing plate suitable for use with inkjet printer such that no post imaging processing required.

It is yet another object of the present invention to provide a lithographic printing plate which can be used on both sides.

### SUMMARY OF THE INVENTION

Accordingly, there is provided a lithographic printing plate suitable for use with inkjet printers as image forming devices, said plate comprising:
(a) a substrate;
(b) at least one base coat provided on the substrate, said base coat obtained from a composition comprising, in a first solvent (i) at least one first hydrophilic binder, (ii) a mixture of pigments comprising at least one porous hydrophilic pigment and at least one non-porous hydrophilic pigment, (iii) at least one first cross-linking agent, and (iv) at least one first catalyst; and
(c) at least one top coat provided on the base coat, said top coat obtained from a composition comprising, in a second solvent (i) at least one second hydrophilic binder, (ii) at least one hydrophilic pigment in particulate form, wherein at least 10% of the pigment particles have particle size of about 3-15 micron; (iii) at least one second cross-linking agent, and (iv) at least one second catalyst.

In an embodiment of the present invention, the substrate has one operative surface and one inoperative surface; said operative surface being provided with at least one base coat and at least one top coat.

In another embodiment of the present invention, the substrate has two operative surfaces, each of said operative surfaces is provided with at least one base coat and at least one top coat.

In another embodiment of the present invention, the substrate is a treated substrate.

In another embodiment of the present invention, the substrate comprises at least one material selected from a group of materials consisting of metal, polymer, paper and their laminates.

In another preferred embodiment of the present invention, the substrate comprises at least one polymer-selected from a group of polymers consisting of a polyester, polycarbonate, polyamide, polyimide, polyolefin and Teflon.

In yet another preferred embodiment of the present invention, the substrate is a multi-layered laminate.

In another embodiment of the present invention, the thickness of the substrate is about 50 to about 400 microns.

In a still another embodiment of the present invention, the first solvent and the second solvent are independently selected from a group of solvents consisting of hydrophilic solvents.

In another preferred embodiment of the present invention, the first solvent and the second solvent are independently selected from a group of solvents consisting of water, (C₁-C₆) alcohol and a mixture thereof.

In another embodiment of the present invention, the first hydrophilic binder and the second hydrophilic binder are independently at least one binder selected from a group of binders consisting of a polymer or a copolymer derived from vinyl monomers, acrylic monomers, anhydride monomers, caprolactam monomers and urethane monomers.

In another preferred embodiment of the present invention, the first hydrophilic binder and the second hydrophilic binder are independently at least one binder selected from a group of binders consisting of a polyester, polyamide, polyimide, polyurethane, polyvinyl alcohol, polyvinyl pyrolidone, polyacrylate, starch, starch derivatives, gelatin, polysaccharide, resins derived from formaldehyde and polyethers.

In another embodiment of the present invention, the hydrophilic pigment is a metal oxide.

In another preferred embodiment of the present invention, the hydrophilic pigment is at least one pigment selected from a group of pigments consisting of silicon dioxide, alumina, zinc oxide, magnesium oxide, titanium oxide, silica, calcium carbonate, kaolin, talc, mica, dolomite, zeolite, gypsum, calcium sulfate and barium sulfate.

In another embodiment of the present invention, the first cross-linking agent and the second cross-linking agent are independently at least one cross-linking agent selected from a group of cross-linking agents consisting of formaldehyde, polyols, glyoxal, aziridine and its derivatives, zirconium ammonium carbonate, alkylated melamine, phenolic resins, boric acid, derivatives of orthosilicate and epoxides.

In another embodiment of the present invention, the first catalyst and the second catalyst are independently at least one catalyst selected from a group of catalysts consisting of organic acid, inorganic acid, organic anhydride, salts of organic acids and derivatives of organic acid.

In another embodiment of the present invention, the porous pigment has a pore volume of about 0.3 to about 3 ml/g.

In one embodiment of the present invention, the non-porous pigment has a pore volume of less than 0.3 ml/g.

In another embodiment of the present invention, not more than 90% by mass of the total hydrophilic pigment in the top coat has a particle size of less than about 400 nanometers.

In yet another embodiment of the present invention, the thickness of the base coat is about 1 to about 25 micron.

In still another embodiment of the present invention, the thickness of the top coat is about 1 to about 25 micron.

In one more embodiment of the present invention, the total pigment content in base coat is less than 90% by mass of the total base coat composition excluding solvent.

In still one more embodiment of the present invention, the non-porous pigment in the base coat is present in an amount from about 50 to 95% by mass of the total pigment content.

In a further embodiment of the present invention, the first hydrophilic binder is present in an amount from about 10 to about 40% by mass of the total base coat composition excluding solvent.

In a still further embodiment of the present invention, the first cross-linking agent is present in an amount from about 0.5 to about 4% by mass of the total base coat composition excluding solvent.

In another embodiment of the present invention, the first catalyst is present in an amount from about 0.4 to about 4% by mass of the total base coat composition excluding solvent.

In another embodiment of the present invention, the total pigment content in the top coat is in the range of about 50 to about 90% by mass of the total top coat composition excluding solvent.

In another embodiment of the present invention, the second hydrophilic binder is present in an amount from about 10 to about 40% by mass of the total top coat composition excluding solvent.

In another embodiment of the present invention, the second cross-linking agent is present in an amount from about 0.5 to about 4% by mass of the total top coat composition excluding solvent.

In another embodiment of the present invention, the second catalyst is present in an amount from about 0.4 to about 4% by mass of the total top coat composition excluding solvent.

In a preferred embodiment of the present invention, the base coat and the top coat are provided on both the sides of the substrate.

In another aspect of the present invention there is provided a process for preparing lithographic printing plate suitable for use with a inkjet printer as an image forming device, comprising: (A) a substrate; (B) at least one base coat provided on the substrate, said base coat obtained from a composition comprising, in a first solvent (i) at least one first hydrophilic binder, (ii) a mixture of pigments comprising at least one porous hydrophilic pigment and at least one non-porous hydrophilic pigment, (iii) at least one first cross-linking agent, and (iv) at least one first catalyst; and (C) at least one top coat provided on the base coat, said top coat obtained from a composition comprising, in a second solvent (i) at least one second hydrophilic binder, (ii) at least one hydrophilic pigment in particulate form, wherein at least 100% of the pigment particles have particle size of about 3-15 micron (iii) at least one second cross-linking agent, and (iv) at least one second catalyst; said process comprising:
(a) Selecting a substrate;
(b) Optionally pre-treating the substrate;
(c) Providing a base coat composition on the substrate
(d) Curing the base coat;
(e) Providing a top coat composition on the base coat; and
(f) Curing the top coat.

In an embodiment of the process described herein, the pre-treatment of the substrate in step (b) includes treatment with at least one substance selected from a group of substances consisting of mineral acid, chlorinated phenol, organic acids, polymeric resins and C₁-C₆ alcohol.

In a preferred embodiment of the process described herein, the pre-treatment of the substrate in step (b) additionally includes at least one process selected from a group consisting of subbing, corona treatment and plasma flame treatment.

In another embodiment of the process described herein, the base coat is provided on the substrate by means of at least one process selected from a group consisting of Meir process, air knife process, reverse role coating process, comma doctor process, gravure coating process and cast coating process.

In another embodiment of the process described herein, the top coat is provided on the base coat by means of at least one process selected from a group consisting of a Meir process, air knife process, reverse role coating process, comma doctor process, gravure coating process and cast coating process.

In another embodiment of the process described herein, the curing in step (d) and (f) is achieved at a surface temperature of less than about 180° C.

In another embodiment of the process described herein, the curing in step (d) and (f) is achieved by means of hot air or infrared radiation.

In an embodiment of the process described herein, the base coat is partially cured in step (d).

In another embodiment of the process described herein, the process for preparing the lithographic printing plate including the steps of forming a base coat composition, providing the base coat composition on the substrate, forming a top coat composition and providing the top coat composition on the base coat.

In another embodiment of the process described herein, the step of forming a base coat composition includes mixing at least one first hydrophilic binder, at least one porous hydrophilic pigment, at least one non-porous hydrophilic pigment, at least one first cross-linking agent and at least one first catalyst in a first solvent.

In another embodiment of the process described herein, the step of forming a top coat composition includes mixing at least one second hydrophilic binder, at least one hydrophilic pigment having particle size of about 3 to about 15 microns, at least one second cross-linking agent and at least one second catalyst in a second solvent.

In yet another embodiment of the process described herein, the step of forming a top coat composition includes mixing at least one second hydrophilic binder, at least one hydrophilic pigment having particle size of about 3 to about 15 microns, at least one pigment having particle size of less than 400 nanometer, at least one second cross-linking agent and at least one second catalyst in a second solvent.

In a preferred embodiment of the process described herein, formation of the coat composition (base coat and top coat) comprises dispersing at least one pigment in a solvent; and adding at least one binder, at least one cross-linking agent and at least one catalyst to the dispersion obtained.

In another aspect of the process described herein, a two-sided lithographic printing plate is prepared by carrying out the steps (a) to (f) on each side of the substrate.

In a preferred embodiment of the process for a two-sided lithographic printing plate described herein, the steps (a) to (f) are carried out in a sequence:
(a) Optionally, pre-treating the first surface,
(b) Optionally pre-treating the second surface,
(c) Providing a base coat on the first surface and optionally curing it,
(d) Providing a base coat on the second surface and optionally curing it,
(e) Providing a top coat on the first surface and optionally curing it, and
(f) Providing a top coat on the second surface and optionally curing it.

In another embodiment of the process described herein, a process for preparing a two-sided lithographic printing plate includes the steps of providing a base coat on the first surface of the substrate, providing a base coat on the second surface of substrate and simultaneously curing the base coat on each surface.

In another embodiment of the process described herein, a process for preparing a two-sided lithographic printing plate includes the steps of providing a top coat on the base coat of the first surface of the substrate, providing a top coat on the base coat of the second surface of substrate and simultaneously curing the top coat on each surface.

Further aspects and embodiments of the invention will become apparent to those skilled in the art from a review of the following detailed description, taken in conjunction with the examples and the claims. It must be understood that that the present disclosure is intended as illustrative only, and is not intended to limit the invention to any specific embodiments described herein.

### DETAILED DESCRIPTION OF THE INVENTION

The term “substrate”, as used herein, unless otherwise indicated or stated, refers to any material which can impart mechanical support to the lithographic printing plate.

The term “hydrophilic” substance, as used herein, unless otherwise indicated or stated, refers to substance which is typically a charge-polarized and capable of hydrogen bonding. The term hydrophilic substance also includes polar substances.

The term “binder”, as used herein, unless otherwise indicated or stated, refers to a material used to bind together two or more other materials in mixtures. The binder includes naturally available materials such as such as natural resin, inorganic materials and alike. Alternatively, the binder can be one synthetically prepared. Non limiting examples of binders include adhesives based on elastomers, thermoplastic, and thermosetting polymers; glue and the like. The term binder also refers to materials can act as binder as a consequence some reaction. Typical non limiting examples of such reactive binders include two-part epoxy, peroxide, silane, metallic cross-links, or isocyanate.

The term “pigment”, as used herein, unless otherwise indicated or stated, refers to any organic or inorganic filler material, capable of receiving ink. The pigment may itself be colored or not colored.

The phrase “cross-linking”, as used herein, unless otherwise indicated or stated, refers to formation of covalent bonds linking one polymer chain to another. The cross-links may be formed chemically or physically. In case of chemical cross-linking, the cross-linking is initiated by initiator such as chemical substance, heat and/or pressure. Cross-links can be made also by purely physical means such as through use of radiations (IR, electron beams etc.). The cross-linking imparts additional structural stability.

The phrase “cross-linking agent”, as used herein, unless otherwise indicated or stated, refers to a substance capable of forming or initiating cross-linking.

The phrase “non-porous pigment”, as used herein, unless otherwise indicated or stated, refers to pigment particles having pore volume of less than 0.3 ml/g.

The phrase “porous pigment”, as used herein, unless otherwise indicated or stated, refers to pigment particles having pore volume of 0.3 to about 3 ml/g.

The phrase “pore volume”, as used herein, unless otherwise indicated or stated, refers to the maximum amount of water held per unit weight of the particle, such that the particle still remains as a solid. For example, a pore volume of 1 ml/g suggest that the particle can hold upto 1 ml of water per gram of particle, and remain as a solid material.

The term “catalyst”, as used herein, unless otherwise indicated or stated, refers to a substance capable of initiating or promoting the cross-linking reaction.

The term “treating”, as used herein, unless otherwise indicated or stated, refers to subjecting to various treatments. Typical, non-limiting examples of treating include, subbing, corona treatment, plasma treatment, chemical treatment and the alike.

The term “curing”, as used herein, unless otherwise indicated or stated, refers to bringing about cross-linking reaction and includes initiation or promotion of a cross-linking reaction.

The term “surface temperature”, as used herein, unless otherwise indicated or stated, refers to the average temperature of the surface at the middle of the heating cycle.

The present invention relates to lithographic printing. Particularly, the present invention relates to a novel lithographic printing plate suitable for use with inkjet printer as image forming devices and a process for its preparation.

The novel lithographic printing plate according to the present invention comprises:
(a) a substrate;
(b) at least one base coat provided on the substrate, said base coat obtained from a composition comprising, in a first solvent (i) at least one first hydrophilic binder, (ii) a mixture of pigments comprising at least one porous hydrophilic pigment and at least one non-porous hydrophilic pigment, (iii) at least one first cross-linking agent, and (iv) at least one first catalyst; and
(c) at least one top coat provided on the base coat, said top coat obtained from a composition comprising, in a second solvent (i) at least one second hydrophilic binder, (ii) at least one hydrophilic pigment in particulate form, wherein at least 10% of the pigment particles have particle size of about 3-15 micron (iii) at least one second cross-linking agent, and (iv) at least one second catalyst.

### (a) Substrate

A substrate imparts mechanical support to the lithographic printing plate. A wide variety of materials can be advantageously used as a substrate according to the present invention. Typical, non limiting examples of materials that can be used as the substrate include, metal, polymer, paper of a combination derived from them. Typical non limiting examples of substrates derived from metal include plates or foils of aluminium, zinc and the like. A wide variety of papers having suitable strength can also be used as substrates. Typical, non limiting examples of paper include glassine paper, poster paper, card board paper, saturated starch paper and the like. Preferably the substrate used is a polymeric substrate. A wide variety of polymers can also be used as substrates. Typical non limiting examples of such polymer substrates includes films, sheets derived from or containing polyesters, polycarbonate, polyamide, polyimide, polyolefin, Teflon and the like. If desired, suitable composite or blend comprising any of the above mentioned polymers may also be advantageously used. Alternatively, a laminate comprising a mix of polymer, metal or paper can also be used. A non limiting example of such multilayer laminate includes alu-alu laminate. Preferably, the substrate is a film containing a biaxially oriented heat set polyester, such as polyethylene terephthalate (PET).

The thickness of the substrate can vary depending on the desired properties, nature of substrate and, operational ease and convenience. Preferably, the substrate has a thickness of about 50 to 400 microns. Preferably, the substrate has a thickness of about 75 to 320 microns. However, a substrate having thickness out of this range can also be used, if desired.

The substrate has at least one operative surface on which a base coat and a top is provided. In case, both sides of the lithographic printing plate are intended to be used, the substrate may have two operative surfaces on which a base coat and a top coat is provided.

The substrate may be treated before providing with a base coat and a top coat to improve the adhesion of the functional coatings to the film. Various methods such as chemical etching, chemical etching in presence of a sub micron non reactive metal oxide pigment such as silica; coating a water dispersible resins such as sulfonated or carboxylated polyester, sulphonated or carboxylated copolymers of vinylidene chloride or fluoride, copolymers of vinyl chloride and vinyl acetate, mineral acid, chlorinated phenol, organic acids, polymeric resins, C₁-C₆ alcohol can be used. Such treatment is commonly known as “subbing process” and is well known in the film coating industry. Alternatively, the substrate may further be subjected to corona discharge or plasma flame treatment which increase the surface tension of the surface, enabling even spread of the coating liquid and thereby providing smooth and uniform coating. The nature and amount of treatment depends on the type of substrate used.

The substrate is then provided with a functional coating such as a base coat and a top coat. The functional coating may be either a single or multiple-layer coating, either on one surface or both the surface of the substrate depending on the desired properties and use. The functional coating should preferably have properties such as enough hardness to withstand the printing pressure; functional compatibility with printing equipment and materials such as ink; imparting high resolution; efficient wetting and drying properties; thermal and process stability. All these properties have been achieved in lithographic printing plate according to the present invention by a judicious selection components and their composition as discussed below:

### (b) Base Coat

A base coat is provided on the operative surface of the substrate and this base coat is obtained from a composition comprising, in a first solvent (i) at least one first hydrophilic binder, (ii) a mixture of pigments comprising at least one porous hydrophilic pigment and at least one non-porous hydrophilic pigment, (iii) at least one first cross-linking agent, and (iv) at least one first catalyst.

(I) First Hydrophilic Binder
The base coat comprises at least one first hydrophilic binder which, binds various constituents in the base coat and maintains the integrity of the base coat. A wide variety of substances can be used as the first hydrophilic binder including the naturally occurring or synthetic substances. Naturally occurring substances that can be used as the first the hydrophilic binder include, without limitation, natural resins, inorganic materials and alike. Synthetic materials that can be used as first hydrophilic binder include, without limitation, various synthetic adhesives such as those containing elastomers, thermoplastic, and thermosetting polymers; glue; chitosan and the like. Alternatively, a wide variety of chemical compounds that may act as a binder as a consequence of some reaction can also be used as a first hydrophilic binder. Typical non limiting examples of such reactive binders include two-part epoxys, peroxides, silanes, metallic cross-links, or isocyanates. Other non-limiting examples of first hydrophilic binders include polymers or copolymers derived from vinyl monomers, acrylic monomers, anhydride monomers, caprolactam monomers and urethane monomers. A wide variety of polymers can also be used as the first hydrophilic binders including, without limitation, polyester, polyamide, polyimide, polyurethane, polyvinyl alcohol, polyvinyl pyrolidone, polyacrylate, polymers of quaternary ammonium monomers, starch, starch derivatives, gelatin, polysaccharide, resins derived from formaldehyde and polyethers, if desired.
Preferably, the first hydrophilic binder is present in an amount from about 10 to about 40% by mass of the total base coat composition excluding the solvent. However, amount below or above these levels may be employed, if desired.

(I) The Pigment
The base coat also comprises a mixture of pigments comprising at least one porous hydrophilic pigment and at least one non-porous hydrophilic pigment. The pigment is any organic or inorganic filler material, capable of receiving ink and may be colored or not colored. A wide variety of hydrophilic materials can be used as pigment. Preferably, the pigment is a metal oxide. Typical non limiting examples of pigments include silicon dioxide, alumina, zinc oxide, magnesium oxide, titanium oxide, silica, calcium carbonate, kaolin, talc, mica, dolomite, zeolite, gypsum, calcium sulfate and barium sulfate.
The base coat comprises a mixture of pigments comprising at least one porous hydrophilic pigment and at least one non-porous hydrophilic pigment. The term non-porous pigment, as used herein refers to pigment particles having pore volume of less than 0.3 ml/g. The term porous pigment, as used herein refers to pigment particles having pore volume of 0.3 to about 3 ml/g. Depending on the method preparation, a given pigment can be obtained as a porous or a non-porous pigment. The term “pore volume” here refers to the maximum amount of water held per unit weight of the particle, such that the particle still remains as a solid. For example, a pore volume of 1 ml/g suggest that the particle can hold upto 1 ml of water per gram of particle, and remain as a solid material.
The amount of the pigment in the coat largely depends on the specific properties desired. Preferably the total pigment content in the base coat is less than 90% by mass of the total base coat composition excluding solvent. Preferably, the non-porous pigment in the base coat is present in an amount from about 50 to 95% by mass of the total pigment content in the base coat.

(III) First Cross-Linking Agent
The base coat also comprises at least one first cross-linking agent. Cross-linking is formation of bonds linking one polymer chain to another. Cross-links may be formed chemically or physically. In case of chemical cross-linking, the cross-linking is initiated by an initiator such as a chemical substance, heat and/or pressure. Cross-links can be made also by purely physical means such as through use of radiations (IR, electron beams etc.). The cross-linking imparts additional structural stability. The cross-linking agent refers to a substance capable of forming or initiating cross-linking. A wide variety of substances can be used as cross-linking agent. Typical non-limiting examples of cross-linking agents that can be used include, formaldehyde, polyols, glyoxal, aziridine and its derivatives, zirconium ammonium carbonate, alkylated melamine, phenolic resins, boric acid, derivatives of orthosilicate and epoxides.
Preferably, the first cross-linking agent is present in an amount from about 0.5 to about 4% by mass of the total base coat composition excluding the solvent. However, amounts below or above these levels may be employed, if desired.

(IV) First Catalyst
The base coat also comprises a first catalyst which is a substance capable of initiating or promoting the cross-linking reaction. A wide variety of substance capable of initiating or promoting the cross-linking reaction can be used as first catalyst. Typical non limiting examples of substances that can be used as the first catalyst include organic acid such as acetic acid, propionic acid and alike; inorganic acid such as hydrochloric acid, sulfuric acid and the like; organic anhydride such as phathalic anhydride and the like, salts of organic acids such as p-toluene sulfonic acid etc and the like; derivatives of organic acids.
Preferably, the first catalyst is present in an amount from about 0.4 to about 4% by mass of the total base coat composition excluding the solvent. However, amounts below or above these levels may be employed, if desired.

(V) First Solvent
The base coat is provided on the operative surface of the substrate and is obtained from a composition comprising, in a first solvent (i) at least one first hydrophilic binder, (ii) a mixture of pigments comprising at least one porous hydrophilic pigment and at least one non-porous hydrophilic pigment, (iii) at least one first cross-linking agent, and (iv) at least one first catalyst.
The first solvent is compatible with all the ingredients of the base coat. Preferably, the first solvent is a hydrophilic solvent. More preferably, the first solvent is water, a (C₁-C₆) alcohol or a mixture thereof. Typical non limiting examples of (C₁-C₆) alcohol includes ethanol, 2-propanol, n-butanol, iso-butanol and the like.

### Preparing a Base Coat Composition

The base composition is prepared in a desired solvent by mixing the individual components in appropriate amounts. Preferably, the base composition is prepared by first dispersing the appropriate quantities of porous and non-porous pigments in the desired solvent and then adding the rest of the components such as the first hydrophilic binder, the first cross-linking agent and the first catalyst.

The final thickness of the base coat in the lithographic printing plate according to this invention is about 1 to about 25 microns. However, lithographic printing plate having thickness below of above this range can be produced according to this invention, if desired.

### (c) Top Coat

The lithographic printing plate according to the present invention has at least one top coat provided on the base coat, said top coat obtained from a composition comprising, in a second solvent (i) at least one second hydrophilic binder, (ii) at least one hydrophilic pigment in particulate form, wherein at least 10% of the pigment particles have particle size of about 3-15 micron (iii) at least one second cross-linking agent, and (iv) at least one second catalyst.

(I) Second Hydrophilic Binder
The top coat comprises at least one second hydrophilic binder which, binds various constituents in the top coat and maintains the integrity of the top coat. A wide variety of substances can be used as a second hydrophilic binder including the naturally occurring or synthetic substances. Naturally occurring substance that can be used as a second hydrophilic binder include, without limitation, natural resins, inorganic materials and alike. Synthetic materials that can be used as second hydrophilic binder include, without limitation, various synthetic adhesives such as those containing elastomers, thermoplastic, and thermosetting polymers; glue; chitosan and the like. Alternatively, a wide variety of chemical compounds that may act as the binder as a consequence of some reaction can also be used as the second hydrophilic binder. Typical non limiting examples of such reactive binders include two-part epoxys, peroxides, silanes, metallic cross-links, or isocyanates. Other non-limiting examples of second hydrophilic binders include polymers or copolymers derived from vinyl monomers, acrylic monomers, anhydride monomers, caprolactam monomers and urethane monomers. A wide variety of polymers can also be used as second hydrophilic binders including, without limitation, polyester, polyamide, polyimide, polyurethane, polyvinyl alcohol, polyvinyl pyrolidone, polyacrylate, starch, starch derivatives, gelatin, polysaccharide, resins derived from formaldehyde and polyethers, if desired.
Preferably, the second hydrophilic binder is present in an amount from about 10 to about 40% by mass of the total top coat composition excluding the solvent However, amount below or above these levels may be employed, if desired.

(II) The Pigment
The top coat comprises at least one hydrophilic pigment in particulate form, wherein at least 10% of the pigment particles have particle size of about 3 to 15 microns. The pigment is any organic or inorganic filler material, capable of receiving ink and may be colored or not colored. A wide variety of hydrophilic materials can be used as pigment. Preferably, the pigment is a metal oxide. Typical non limiting examples of pigments include silicon dioxide, alumina, zinc oxide, magnesium oxide, titanium oxide, silica, calcium carbonate, kaolin, talc, mica, dolomite, zeolite, gypsum, calcium sulfate and barium sulfate. According to the present invention, least 10% by mass of total pigment in the top coat have particle size of about 3 to 15 microns. Preferably, 90% by mass of the total hydrophilic pigment in the top coat has a particle size of less than about 400 nanometers. This judicious selection of pigments of different particle size in the top coat is one of the features of the present invention. The top coat may contain the same pigment as in the base coat but in different particle size.
The amount of the pigment in the top coat largely depends on the specific properties desired. Preferably the total pigment content in a top coat is in the range of about 50 to about 90% by mass of the total top coat composition, excluding the solvent.

(III) Second Cross-Linking Agent
The top coat also comprises at least one second cross-1 inking agent. Cross-linking is formation of covalent bonds linking one polymer chain to another. Cross-links may be formed chemically or physically. In case of chemical cross-linking, the cross-linking is initiated by initiator such as chemical substance, heat and/or pressure. Cross-links can be made also by purely physical means such as through use of radiations (IR, electron beams etc.). The cross-linking imparts additional structural stability. The cross-linking agent refers to a substance capable of forming or initiating cross-linking. A wide variety of substances can be used as the second cross-linking agent. Typical non-limiting examples of second cross-linking agents that can be used include formaldehyde, polyols, glyoxal, aziridine and its derivatives, zirconium ammonium carbonate, alkylated melamine, phenolic resins, boric acid, derivatives of orthosilicate and epoxides.
Preferably, the second cross-linking agent is present in an amount from about 0.5 to about 4% by mass of the total top coat composition excluding the solvent. However, amount below or above these levels may be employed, if desired.

(IV) Second Catalyst
The top coat also comprises a second catalyst which is a substance capable of initiating or promoting the cross-linking reaction. A wide variety of substance capable of initiating or promoting the cross-linking reaction can be used as the second catalyst. Typical non limiting examples of substances that can be used as the second catalyst include organic acid such as acetic acid, propionic acid and the like; inorganic acid such as hydrochloric acid, sulfuric acid and the like; organic anhydride such as maleic anhydride and alike, salts of organic acids such as p-toluene sulfonic acid etc and the like; derivatives of organic acids.
Preferably, the second catalyst is present in an amount from about 0.4 to about 4% by mass of the total top coat composition excluding the solvent. However, amounts below or above these levels may be employed, if desired.

(V) Second Solvent
The top coat is provided on the base coat and is obtained from a composition comprising, in a second solvent (i) at least one second hydrophilic binder, (ii) at least one hydrophilic pigment in particulate form, wherein at least 10% of the pigment particles have particle size of about 3-15 micron, (iii) at least one second cross-linking agent, and (iv) at least one second catalyst.
The second solvent is compatible with all the ingredients of the top coat. Preferably, the second solvent is a hydrophilic solvent. More preferably, the second solvent is water, a (C₁-C₆) alcohol or a mixture thereof. Typical non limiting examples of (C₁-C₆) alcohol includes ethanol, 2-propanol, n-butanol, iso-butanol and the like.

### Preparing a Top Coat Composition

The top coat composition is prepared in desired solvent by mixing the individual components in appropriate amounts. Preferably, a top coat composition is prepared by first dispersing the appropriate quantities of pigment in the desired solvent and then adding the rest of the components such as the second hydrophilic binder, the second cross-linking agent and the second catalyst.

The final thickness of the top coat in the lithographic printing plate according to this invention is about 1 to about 25 microns. However, lithographic printing plate having thickness below of above this range can be produced according to this invention, if desired.

The substrate may be provided with a base coat and a top coat on one side or both sides.

In another aspect, there is provided a process for preparing a lithographic printing plate according to the present invention, said process comprising:
(a) Selecting a substrate;
(g) Optionally pre-treating the substrate;
(h) Providing a base coat composition on the substrate
(i) Curing the base coat;
(j) Providing a top coat composition on base coat; and
(k) Curing the top coat.

The appropriate substrate (such as a polymer film, metal plate and the like) is optionally pre-treated before providing a base coat and a top coat to improve the adhesion of the functional coatings to the substrate. Various methods such as chemical etching, chemical etching in presence of a sub micron non reactive metal oxide pigment such as silica; coating a water dispersible resins such as sulphonated or carboxylated polyester, sulphonated or carboxylated copolymers of vinylidene chloride or fluoride, copolymers of vinyl chloride and vinyl acetate, mineral acid, chlorinated phenol, organic acids, polymeric resins, C₁₋₆ alcohol can be used. Such treatment is commonly known as “subbing process” and is well known in the film coating industry. Alternatively, the substrate may further be subjected to corona discharge or plasma flame treatment which increase the surface tension of the surface, enabling even spread of the coating liquid and thereby providing smooth and uniform coating. The nature and amount of treatment depends on the type of substrate used.

After the optional pre-treatment, the substrate is provided with the base coat composition by any known process including the Meir process, air knife process, reverse role coating process, comma doctor process, gravure coating process and cast coating process. The base coat composition is prepared as described above. The substrate with a base coat is then cured such that the surface temperature during curing is not more than about 180° C.

A top coat is then provided on the base coat by any known process including the Meir process, air knife process, reverse role coating process, comma doctor process, gravure coating process and cast coating process. The substrate with a base coat and a top coat is then cured such that the surface temperature is not more than about 180° C.

The curing may be accomplished using various methods known in the art including hot air and radiation induced curing. The curing is preferably carried out under such condition that the surface temperature is not more than about 180° C. The curing may be partial curing or complete curing.

In another variation of the process described herein for preparing the lithographic printing plate includes the steps of forming a base coat composition, providing the base coat composition on substrate, forming a top coat composition and providing the top coat composition on the base coat, and then curing the substrate having the base coat and the top coat.

In another aspect of the present invention, a two-sided lithographic printing plate is prepared by carrying out the steps (a) to (f) on each side of the substrate.

In another aspect of the invention, a two-sided lithographic printing plate described is prepared in the following sequences:
(a) Selecting the substrate
(b) Optionally, pre-treating the first surface,
(c) Optionally pre-treating the second surface,
(d) Providing a base coat on the first surface and optionally curing it,
(e) Providing a base coat on the second surface and optionally curing it,
(f) Providing a top coat on the first surface and optionally curing it, and
(g) Providing a top coat on the second surface and optionally curing it.

In one variation of the process the process for preparing a two-sided lithographic printing plate includes the steps of providing a base coat on first surface of the substrate, providing a base coat on the second surface of substrate and simultaneously curing the base coat on each surface and repeating this sequence for the top coat.

### EXAMPLES

The present invention is described in more details with reference to following examples that are merely for the purpose of illustration and are not to be regarded as limiting the scope of the invention or the manner in which it can be practiced.

The following examples explain few typical formulations, which are the main vehicle of the invention of a lithographic printing plate, which can be imaged by an ink jet printer.

### Example 1

A 125 micron biaxially oriented polyester film (substrate) having both surfaces subbed by chemical etching, was coated with a base coat formulation BC1 using a wire wound bar and dried at 130° C. in an air oven for about 2 minutes to get a base coat having dry thickness of about 11 micron. In a similar fashion the backside was also coated using the base coat composition BC1 and dried accordingly. Both sides of the base coated substrate were then coated with a top coat formulation TC1 and dried in an air oven at 130° C. for about 4 minutes to get top coat having dry thickness of about 7 micron.

Base coat formulation BC1 was prepared by mixing the following ingredients in a vessel using a high-speed stirrer in distilled water.
1. First hydrophilic binder: 4 parts of polyvinyl alcohol (about 98-99% hydrolyzed and having molecular weight of about 15,000-20,000);
2. Porous pigment: 0.6 parts of amorphous silica having pore volume of 1.2 ml/g;
3. Non-porous pigment: 19 parts of titanium dioxide having pore volume of less than 0.3 ml/g and 2.5 parts of colloidal silica having particle size of about 20 nanometer;
4. First cross-linking agent: 0.8 parts of glyoxal (40% aqueous solution);
5. First catalyst: 0.3 parts of methane sulfonic acid; and
6. First solvent: distilled water to make up the composition to 100 parts.

Top coat formulation TC1 was prepared by mixing the following ingredient in a vessel using high-speed stirrer in distilled water.
1. Second hydrophilic binder: 2.5 parts medium molecular weight (about 15,000-20,000) polyvinyl alcohol which is about 98-99% hydrolyzed; and 0.8 parts of low molecular weight (about 5,000) polyvinyl alcohol which is about 88-89% hydrolyzed;
2. Pigment: 1.25 parts of amorphous silica having pore volume of 1.2 ml/g and particle size of 5-7 micron; 8 parts of aluminum oxide having particles of less than 400 nanometer and 0.4 parts of colloidal silica having articles size of about 40 nanometer;
3. Second cross-linking agent: 0.8 parts of glyoxal (40% aqueous solution);
4. Second catalyst: 0.3 parts of methane sulfonic acid; and
5. Second solvent: distilled water to make up the composition to 100 parts.

### Test 1

The lithographic printing plate obtained in accordance with the procedure as stated hereinabove was tested for its performance using GATF digital test target (Digital plate control target 1.0, available from Graphic Arts Technical Foundation). The plate was printed with this target file using an Epson 7800 printer at 50% ink level using the Raster Imaging Processing software (OpenRip™, RIPit Corporation, USA). The plate was then mounted on to an AB Dick press and subjected to 30,000 impressions. The test results are given in Table 1.

TABLE 1
Print result of the plates prepared in Example 1
(Run length test for 30000 impressions)

| | |
|---|---|
| Background area | No ink pick up |
| Line 1.00-point | clear |
| Line 0.1-point | clear |
| Line 0.01-point | clear |
| Line 1.00-point (Reverse) | clear |
| Line 0.2-point (Reverse) | clear |
| Line 0.1-point (Reverse) | filled |

The results in Table 1 indicate that the lithographic plate prepared according to Example 1 can print at least 30,000 impressions without losing the print quality.

### Test 2

Another lithographic printing plate coated on both sides was prepared according the procedure given in Example 1. Both sides were imaged using same image for GATF test as given in Example 1. Then, one side of the plate was printed using ABDick offset printer for 30,000 impressions. The print results were similar to those given in Table 1. Then, the remaining side of the plate was printed using the same ABDick offset printer for 10,000 impressions and the print results are given in Table 2.

TABLE 2
Print result on the back side (after printing 30,000
impressions on the front side of the plates).

| | |
|---|---|
| Background area | No ink pick up |
| Line 1.00-point | clear |
| Line 0.1-point | clear |
| Line 0.01-point | clear |
| Line 1.00-point (Reverse) | clear |
| Line 0.2-point (Reverse) | clear |
| Line 0.1-point (Reverse) | filled |

The results in Table 2 indicate that the lithographic plate prepared according to Example 2 can print at least 10,000 impressions without losing the print quality, even after having printed at least 30,000 impressions on the other side.

### Test 3

Another lithographic printing plate coated on both sides was prepared according the procedure given in Example 1. The plate was imaged on both sides and the plate was fused in an air oven (set at 110° C.) for about one minute and then printed using ABDick printer for 50,000 impressions on one side and 30,000 on the reverse side. The results are shown in Table 3A and Table 3B.

TABLE 3A
Print result for one side for 50,000 impressions

| | |
|---|---|
| Background area | No ink pick up |
| Line 1.00-point | clear |
| Line 0.1-point | clear |
| Line 0.01-point | clear |
| Line 1.00-point (Reverse) | clear |
| Line 0.4-point (Reverse) | clear |
| Line 0.2-point (Reverse) | filled |
| Line 0.1-point (Reverse) | filled |

TABLE 3B
Print result for reverse side for 30,000 impressions

| | |
|---|---|
| Background area | No ink pick up |
| Line 1.00-point | clear |
| Line 0.1-point | clear |
| Line 0.01-point | clear |
| Line 1.00-point (Reverse) | clear |
| Line 0.4-point (Reverse) | clear |
| Line 0.2-point (Reverse) | clear |
| Line 0.1-point (Reverse) | filled |

The results indicate the at least 50,000 impressions can be obtained using the lithographic plate prepared according to Example 1.

### Example 2

Plates were prepared as in Example 1 except for a change that the thickness of the substrate was 175 micron and drying temperature in the oven was 135° C. The plates were subjected to the same series of tests as for the plates in example 1 The results obtained were similar to those obtained in Example 1.

### Example 3

Plates were prepared as in Example 1 except for the change that the top coat (TC1) was coated directly on the substrate to get a dry thickness of 12 micron without any base coat The plates thus obtained were tested for performance as explained in Example 1 and the results are given below (for 100 impressions).
Background: Not clear (0.35 density on a Gretag densitometer model D19C)
Background area: No ink pick up
Line 1.00-point: Filled up
Line 1.00-point (Reverse): filled up
Halftone image: filled up with ink bleeding.

The results given above indicate that the print quality is not maintained at acceptable levels even for first 100 impressions thereby suggesting that the presence of base coat is essential for longer performance.

### Example 4

Plates were prepared as in Example 1 except for a change that the top coat (TC2) had a following formulation.
1. Second hydrophilic binder: 4.5 parts medium molecular weight (about 15,000-20,000) polyvinyl alcohol which is about 98-99% hydrolyzed; and 0.2 parts of low molecular weight (about 5,000) polyvinyl alcohol which is about 88-89% hydrolyzed;
2. Pigment: 1.25 parts of amorphous silica having pore volume of 1.2 ml/g and particle size of 5-7 micron; 8 parts of aluminum oxide having particles of less than 400 nanometer and 0.4 parts of colloidal silica having articles size of about 40 nanometer;
3. Second cross-linking agent: 0.8 parts of glyoxal (40% aqueous solution);
4. Second catalyst: 0.4 parts of methane sulfonic acid; and
5. Second solvent: distilled water to make up the composition to 100 parts.

The lithographic printing plates thus obtained were tested for performance as described in Example 1 for 5,000 impressions and results are given below.

| | |
|---|---|
| Background area: | back ground density 0.12 |
| | (Gretag densitometer D19C) |
| Line 1.00-point: | clear |
| Line 0.1-point: | clear |
| Line 0.01-point: | clear |
| Line 1.00-point (Reverse): | clear |
| Line 0.4-point (Reverse): | partially filled |
| Line 0.2-point (Reverse): | filled |

This shows that shifting the pigment binder ratio has influence on the print performance of the plate.

### Example 5

Plates were prepared as in Example 1 except for the change that the non-porous pigment in the base coat was micronized clay having pore volume of less than 0.3 ml/g instead of titanium dioxide. The print results for 30,000 impressions are given below:

| | |
|---|---|
| Background area | No ink pick up |
| Line 1.00-point | clear |
| Line 0.1-point | clear |
| Line 0.01-point | clear |
| Line 1.00-point (Reverse) | clear |
| Line 0.2-point (Reverse) | clear |
| Line 0.1-point (Reverse) | filled |

### Example 6

Plates were prepared as in Example 1 except for the change that the top coat formulation was made using following ingredients.
1. Second hydrophilic binder: 2.5 parts medium molecular weight (about 15,000-20,000) polyvinyl alcohol which is about 98-99% hydrolyzed; and 0.8 parts of low molecular weight (about 5,000) polyvinyl alcohol which is about 88-89% hydrolyzed;
2. Pigment: 1.25 parts of amorphous silica having pore volume of 1.2 ml/g and particle size of 5-7 micron; 7.5 parts of fumed silica having particle of about 100-140 nanometers incorporated as a dispersion in water;
3. Second cross-linking agent: 0.8 parts of glyoxal (40% aqueous solution);
4. Second catalyst: 0.3 parts of methane sulfonic acid; and
5. Second solvent: distilled water to make up the composition to 100 parts

The print results for 30,000 impressions according to the procedure given in Example are given below.

| | |
|---|---|
| Background area | No ink pick up |
| Line 1.00-point | clear |
| Line 0.1-point | clear |
| Line 0.01-point | clear |
| Line 1.00-point (Reverse) | clear |
| Line 0.2-point (Reverse) | clear |
| Line 0.1-point (Reverse) | filled |

### Example 7

Plates were prepared as in Example 1 except for the change that the thickness of the substrate was 250 micron and drying temperature in the oven was 140° C. The plates were subjected to the same series of tests as for the plates in example 1 The results obtained were similar to those obtained in Example 1.

### Example 8

Plates were prepared as in Example 1 except for the change that the substrate was a treated aluminum plate having thickness of about 150 micron and drying temperature in the oven was 135° C. The plates were subjected to the same series of tests as for the plates in example 1 The results obtained were similar to those obtained in Example 1.

### Example 9

Plates were prepared as in Example 1 except for the change that the substrate was a laminate having thickness of about 150 micron (polyester film (100 micron)+aluminium foil (50 micron)) and drying temperature in the oven was 135° C. The plates were subjected to the same series of tests as for the plates in example 1 The results obtained were similar to those obtained in Example 1.

### Example 10

Plates were prepared as in Example 1 except for the change that the base coat formulation was prepared using following ingredients.
1. First hydrophilic binder: 6 parts of corn starch;
2. Porous pigment: 0.6 parts of amorphous silica having pore volume of 1.2 ml/g;
3. Non-porous pigment: 19 parts of titanium dioxide having pore volume of less than 0.3 ml/g and 2.5 parts of colloidal silica having particle size of about 20 nanometer;
4. First cross-linking agent: 0.8 parts of aziridine (cross-linker 100 (DSM Neoresin))
5. First catalyst: 0.3 parts of p-toluene sulfonic acid neutralized with ammonia to pH 9; and
6. First solvent: 3 parts of isopropanol; distilled water to make up the composition to 100 parts

The plates were subjected to the same series of tests as for the plates in example 1 The results obtained were similar to those obtained in Example 1.

### Example 11

Plates were prepared as in Example 1 except for the change that the first and the second cross-linking agent in the base coat and the top coat formulation respectively, was butylated melamine formaldehyde resin. The plates were subjected to the same series of tests as for the plates in example 1 The results obtained were similar to those obtained in Example 1.

### ADVANTAGEOUS FEATURES OF THE INVENTION

Some of the advantageous features of the instant invention include:
1. The lithographic printing plate according the instant invention is easy to use, economic and uses environmental friendly ingredients.
2. The lithographic printing plate according the instant invention can be efficiently used for small as well as medium run length application.
3. The lithographic printing plate according the instant invention can be used on both side saving cost and time.
4. The lithographic printing plate according the instant invention has improved durability and stability.

All references including patents, patent applications, and literature cited in the specification are expressly incorporated herein by reference in their entirety. The invention has been described with reference to various specific and preferred embodiments and techniques, and reference has also been made to possible variations within the scope of the invention. However, these and other variations and modifications in the disclosure will be apparent to those skilled in the art without departing from the scope of the disclosure, and it should be understood that this disclosure and the claims shown below are not limited to the illustrative embodiments set forth herein. In the case of any inconsistencies, the present disclosure, including any definitions therein will prevail.

1. A lithographic printing plate suitable for use with inkjet printers as an image forming device, said plate comprising:
(a) a substrate;
(b) at least one base coat provided on the substrate, said base coat obtained from a composition comprising, in a first solvent (i) at least one first hydrophilic binder, (ii) a mixture of pigments comprising at least one porous hydrophilic pigment and at least one non-porous hydrophilic pigment, (iii) at least one first cross-linking agent, and (iv) at least one first catalyst; and
(c) at least one top coat provided on the base coat, said top coat obtained from a composition comprising, in a second solvent (i) at least one second hydrophilic binder, (ii) at least one hydrophilic pigment in particulate form, wherein at least 10% of the pigment particles have particle size of about 3-15 micron (iii) at least one second cross-linking agent, and (iv) at least one second catalyst.

2. A lithographic printing plate as claimed in claim 1, wherein the substrate has one operative surface and one inoperative surface, said operative surface being provided with at least one base coat and at least one top coat.

3. A lithographic printing plate as claimed in claim 1, wherein the substrate has two operative surfaces and each of said operative surfaces is provided with at least one base coat and at least one top coat.

4. A lithographic printing plate as claimed in claim 1, wherein the substrate is a treated substrate.

5. A lithographic printing plate as claimed in claim 1, wherein the substrate comprises at least one material selected from a group consisting of metal, polymer paper and their laminates.

6. A lithographic printing plate as claimed in claim 1, wherein the substrate comprises at least one polymer selected from a group of polymers consisting of a polyester, polycarbonate, polyamide, polyimide, polyolefin and Teflon.

7. A lithographic printing plate as claimed in claim 1, wherein the substrate is a multi-layered laminate.

8. A lithographic printing plate as claimed in claim 1, wherein the thickness of the substrate is about 50 to about 400 microns.

9. A lithographic printing plate as claimed in claim 1, wherein the first solvent and the second solvent is independently selected from a group of solvents consisting of hydrophilic solvents.

10. A lithographic printing plate as claimed in claim 1, wherein the first solvent and the second solvent is independently selected from a group of solvents consisting of water, (C₁-C₆) alcohol or a mixture thereof.

11. A lithographic printing plate as claimed in claim 1, wherein the first hydrophilic binder and the second hydrophilic binder is independently at least one binder selected from a group of binders consisting of a polymer or a copolymer derived from vinyl monomers, acrylic monomers, anhydride monomers, caprolactam monomers and urethane monomers.

12. A lithographic printing plate as claimed in claim 1, wherein the first hydrophilic binder and the second hydrophilic binder is independently at least one binder selected from a group of binders consisting of a polyester, polyamide, polyimide, polyurethane, polyvinyl alcohol, polyvinyl pyrolidone, polyacrylate, starch, starch derivatives, gelatin, polysaccharide, resins derived from formaldehyde and polyethers.

13. A lithographic printing plate as claimed in claim 1, wherein the hydrophilic pigment is a metal oxide.

14. A lithographic printing plate as claimed in claim 1, wherein the hydrophilic pigment is at least one pigment selected from a group of pigments consisting of silicon dioxide, alumina, zinc oxide, magnesium oxide, titanium oxide, silica, calcium carbonate, kaolin, talc, mica, dolomite, zeolite, gypsum, calcium sulfate and barium sulfate.

15. A lithographic printing plate as claimed in claim 1, wherein the first cross-linking agent and the second cross-linking agent is independently at least one cross-linking agent selected from a group of cross-linking agents consisting of formaldehyde, polyols, glyoxal, aziridine and its derivatives, zirconium ammonium carbonate, alkylated melamine, phenolic resins, boric acid, derivatives of orthosilicate and epoxides.

16. A lithographic printing plate as claimed in claim 1, wherein the first catalyst and the second catalyst is independently at least one catalyst selected from a group of catalysts consisting of organic acid, inorganic acid, organic anhydride, salts of organic acids and derivatives of organic acid.

17. A lithographic printing plate as claimed in claim 1, wherein not more than 90% by mass of the total hydrophilic pigment in the top coat has a particle size less than about 400 nanometers.

18. A lithographic printing plate as claimed in claim 1, wherein thickness of the base coat is about 1 micron to about 25 micron.

19. A lithographic printing plate as claimed in claim 1, wherein thickness of the top coat is about 1 micron to about 25 micron.

20. A lithographic printing plate as claimed in claim 1, wherein the total pigment content in base coat is less than 90% by mass of the total base coat composition excluding solvent.

21. A lithographic printing plate as claimed in claim 1, wherein the non-porous pigment in the base coat is present in an amount from about 50 to 95% by mass of the total pigment content.

22. A lithographic printing plate as claimed in claim 1, wherein the first hydrophilic binder is present in an amount from about 10 to about 40% by mass of the total base coat composition excluding solvent.

23. A lithographic printing plate as claimed in claim 1, wherein the first cross-linking agent is present in an amount from about 0.5 to about 4% by mass of the total base coat composition excluding solvent.

24. A lithographic printing plate as claimed in claim 1, wherein the first catalyst is present in an amount from about 0.4 to about 4% by mass of the total base coat composition excluding solvent.

25. A lithographic printing plate as claimed in claim 1, wherein the total pigment content in the top coat is in the range of about 50 to about 90% by mass of the total top coat composition excluding solvent.

26. A lithographic printing plate as claimed in claim 1, wherein the second hydrophilic binder is present in an amount from about 10 to about 40% by mass of the total top coat composition excluding solvent.

27. A lithographic printing plate as claimed in claim 1, wherein the second cross-linking agent is present in an amount from about 0.5 to about 4% by mass of the total top coat composition excluding solvent.

28. A lithographic printing plate as claimed in claim 1, wherein the second catalyst is present in an amount from about 0.4 to about 4% by mass of the total top coat composition excluding solvent.

29. A lithographic printing plate ac claimed in claim 1, wherein the base coat and the top coat are provided on both the sides of the substrate.

30. A process for preparing a lithographic plate as claimed in claim 1 comprising:
(a) Selecting a substrate;
(b) Optionally pre-treating the substrate,
(c) Providing a base coat composition on the substrate;
(d) Curing the base coat;
(e) Providing a top coat composition on base coat; and
(f) Curing the top coat.

31. A process as claimed in claim 30, wherein the pre-treatment of the substrate in step (b) includes treatment with at least substance selected from a group of substances comprising mineral acid, chlorinated phenol, organic acids, polymeric resins, C₁-C₆ alcohol.

32. A process as claimed in claim 30, wherein the pre-treatment of a substrate in step (b) includes at least one process selected from a group comprising subbing, corona treatment or plasma flame treatment.

33. A process as claimed in claim 30, wherein the base coat is provided on the substrate by means of at least one process selected from a group comprising Meir process, air knife process, reverse role coating process, comma doctor process, gravure coating process and cast coating process.

34. A process as claimed in claim 30, wherein the top coat is provided on the base coat by means of at least one process selected from a group comprising Meir process, air knife process, reverse role coating process, comma doctor process, gravure coating process and cast coating process.

35. A process as claimed in claim 30, wherein the curing in step (d) and (f) is achieved at a surface temperature of less than about 180° C.

36. A process as claimed in claim 30, wherein the curing in step (d) and (f) is achieved by means of hot air or infrared radiation.

37. A process as claimed in claim 30, wherein the base coat is partially cured in step (d).

38. A process as claimed in claim 30, including the steps of forming a base coat composition, providing the base coat composition on substrate, forming a top coat composition and providing the top coat composition on the base coat.

39. A process as claimed in claim 38, wherein the step of forming a base coat composition includes mixing at least one first hydrophilic binder, at least one porous hydrophilic pigment, at least one non-porous hydrophilic pigment, at least one first cross-linking agent and at least one first catalyst in a first solvent.

40. A process as claimed in claim 38, wherein the step of forming a top coat composition includes mixing at least one second hydrophilic binder, at least one hydrophilic pigment having particle size of about 3 to about 5 microns, at least one second cross-linking agent and at least one second catalyst in a second solvent.

41. A process as claimed in claim 39-40, wherein formation of the coat composition comprises:
(a) Dispersing at least one pigment in a solvent, and
(b) Adding at least one binder, at least one cross-linking agent and at least one catalyst to the dispersion obtained in step (a).

42. A process as claimed in claim 30, wherein the steps (a) to (f) are carried out on each side of the substrate.

43. A process as claimed in claim 30 wherein the steps (a) to (f) are carried out in a sequence:
(a) Optionally, pre-treating the first surface,
(b) Optionally pre-treating the second surface,
(c) Providing a base coat on the first surface and optionally curing it,
(d) Providing a base coat on the second surface and optionally curing it,
(e) Providing a top coat on the first surface and optionally curing it, and
(f) Providing a top coat on the second surface and optionally curing it.

44. A process as claimed in claim 43, including the steps of providing a base coat on first surface of the substrate, providing a base coat on the second surface of substrate and simultaneously curing the base coat on each surface.

45. A process as claimed in claim 43, including the steps of providing a top coat on the base coat of the first surface of the substrate, providing a top coat on the base coat of the second surface of substrate and simultaneously curing the top coat on each surface.
